(19) United States
(12) Patent Application Publication
(10) Pub. No.: US 2021/0319136 A1
(43) Pub. Date: Oct. 14, 2021

(54) VERIFYING AUTHENTICITY OF CONTENT OF ELECTRONIC DOCUMENTS

(71) Applicant: UST Global (Singapore) Pte. Ltd., Singapore (SG)

(72) Inventors: Hari Prasad Chandrashekaran Nair, Thiruvananthapuram (IN); Satheesh Gopalakrishnapillai, Thiruvananthapuram (IN); Aby Jacob, Thiruvananthapuram (IN)

(21) Appl. No.: 16/903,832

(22) Filed: Jun. 17, 2020

(30) Foreign Application Priority Data
Apr. 2, 2020 (IN) 202011014779

(51) Int. Cl. G06F 21/64; G06F 16/13; H04L 9/06; G06F 16/14

(52) U.S. Cl. CPC G06F 21/64; G06F 16/152; H04L 9/0643; G06F 16/137

(57) ABSTRACT

In an embodiment, a computer-implemented method of verifying authenticity of content of electronic documents. The method comprises receiving, in a first session, an electronic document. The method further comprises creating a first hash associated with the electronic document, where the first hash is based on first content included in the electronic document. The method further comprises creating a second hash associated with the electronic document, where the second hash is based on a first set of pixels associated with the electronic document. The method further comprises storing the first hash and the second hash in a data store for verifying the authenticity of the content of the electronic document during a second session.

### CROSS-REFERENCE TO RELATED APPLICATIONS

This application claims the benefit of Indian Provisional Application No. 202011014779, filed Apr. 2, 2020, which is herein incorporated by reference in its entirety.

### FIELD OF THE INVENTION

The present disclosure, in general, relates to the security of documents and in particular, relates to verifying the authenticity of the content of electronic documents.

### BACKGROUND

Conventional techniques for validating or verifying the authenticity of documents include QR based mechanisms or techniques that involve the use of digital signature. However, these popular mechanisms can be easily spoofed and can also give loophole for document forgers to change and edit the document content. For instance, the content of a document may be easily tampered with and this may prove to be harmful for an innocent party, for example, in the case of a contract. If digital signatures are used, they are expensive and at the same time spoofable & vulnerable to various hacks.

Thus, there is a need for a solution that overcomes the above deficiencies.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

In an embodiment, a computer-implemented method of verifying the authenticity of content of electronic documents. The method comprises receiving, in a first session, an electronic document. The method further comprises creating a first hash associated with the electronic document, where the first hash is based on first content included in the electronic document. The method further comprises creating a second hash associated with the electronic document, where the second hash is based on a first set of pixels associated with the electronic document. The method further comprises storing the first hash and the second hash in a data store for verifying the authenticity of the content of the electronic document during a second session.

In another embodiment, a document verification system for verifying authenticity of content of electronic documents is disclosed. The system comprises a processor and a document handler coupled to the processor and configured to receive, in a first session, an electronic document. The system further comprises a hashing engine coupled to the processor. The hashing engine is configured to create a first hash associated with the electronic document. Herein, the first hash is based on first content included in the electronic document. Furthermore, the hashing engine is configured to create a second hash associated with the electronic document. Herein the second hash is based on a first set of pixels associated with the electronic document. The system further comprises a verification engine coupled to the processor. The verification engine is configured to store the first hash and the second hash in a data store for verifying the authenticity of the content of the electronic document during a second session.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope.

The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an environment implementing a Document Verification System (DVS), according to one or more embodiments of the present subject matter;

FIG. 2 illustrates, a schematic block diagram illustrating various components of the DVS, according to one or more embodiments of the present subject matter;

FIG. 3 illustrates a computer-implemented method of verifying the authenticity of the content of electronic documents, according to one or more embodiments of the present subject matter;

FIG. 4 illustrates a computer-implemented method of verifying the authenticity of the content of electronic documents, according to one or more embodiments of the present subject matter; and

FIG. 5 illustrates a computer-implemented method of verifying the authenticity of the content of electronic documents, according to one or more embodiments of the present subject matter.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this invention belongs. The system, methods, and examples provided herein are illustrative only and not intended to be limiting.

Embodiments of the present invention will be described below in detail with reference to the accompanying drawings.

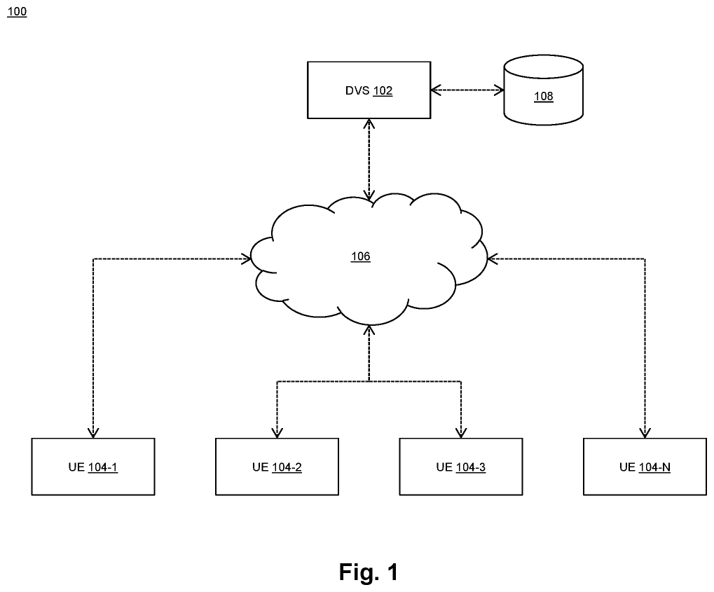

FIG. 1 illustrates an environment 100 implementing a Document Verification System (DVS) 102, according to one or more embodiments of the present subject matter. The environment 100 further includes one or more User Equipment (UE) 104-1, 104-2, 104-3, . . . , and 104-N, and a communication network 106. The one or more UE 104-1, 104-2, 104-3, . . . , and 104-N, hereinafter, may collectively be referred to as the UEs 104 and individually be referred to as the UE 104.

Examples of the DVS 102 may include but are not limited to, a server, a cloud server, a local server, a workplace server, a distributed computing system, a desktop computer, a laptop, a tablet, and a smartphone. Examples of the UE 104 may include but are not limited to, a server, a cloud server, a local server, a workplace server, a desktop computer, a laptop, a tablet, and a smartphone. In an example, the communication network 106 may include any number of wired or wireless networks, implementing various communication protocols and/or technologies that enable the communication between the UEs 104 and the DVS 102. In an example, the DVS 102 may be communicably coupled to the UEs 104, through the communication network 106.

According to an example embodiment of the present subject matter, the DVS 102 may be configured to verify the authenticity of the content of electronic documents provided to the DVS 102 by the UEs 104. In other words, given an electronic document, according to aspects of the present subject matter, the DVS 102 may be configured to determine whether the content of the electronic document has been tampered with or not. Examples of the electronic document may include but are not limited to, a text file, a Portable Document Format (PDF) file, an image file including text. According to further aspects of the present subject matter, the DVS 102 may be configured to determine a probable region within the electronic document, where the tampered content may be present.

In an example, a user seeking to use the services of the DVS 102 may at first register with the DVS 102 using, say, the UE 104-1. The registration of the user with the DVS 102 may include subscribing to one or more subscription plans that provide for varying levels of the verficiation of the authenticity of the content of electronic documents. For instance, in a first subscription plan, the DVS 102 may only provide for determining whether the content of a given electronic document has been tampered with or not. In another subscription plan, in addition to the aforementioned, the DVS 102 may also provide for the determining of the probable region where the content tampering may have occurred. In yet another subscription plan, in addition to the aforementioned, the DVS 102 may provide for linking of related documents, as would be described in further detail in the description below.

In an example embodiment, after the user is successfully registered with the DVS 102, the user may provide to the DVS 102 using the UE 104-1, an electronic document whose content is sought to be secured. This providing of the electronic document may include transmission of the electronic document by the UE 104-1 to the DVS 102 in a first session.

In an example embodiment, on receiving the electronic document, the DVS 102 may be configured to create two hashes associated with the electronic document. In an example, the first hash may be a hash that is based on first content included in the electronic document. The first content, as used herein, may be understood as the content of the electronic document as received during the first session. The content herein may be either the complete content or partial content, for example, selected portions of the content. In another example, content herein can refer to the human-readable, visible parts of the electronic document, such as text, graphics, and the like, that would be visible to a human reader using an electronic interface such as an electronic video display. In this example, content would not include invisible parts of the electronic document, such as metadata. In other examples, any of the hashes generated herein can be based at least in part on metadata of the electronic document.

Furthermore, in said example embodiment, the second hash may be a hash that is based on a first set of pixels associated with the electronic document. In an example, the first set of pixels may represent a pixel graph associated with the first content of the electronic document. In another example, the first set of pixels may be pixels obtained by processing the electronic document using a raster scanning technique. In an example embodiment, where the electronic document is a text document, the electronic document may first be converted to an image of a predefined format. Subsequently, the first set of pixels may be obtained based on the converted electronic document. Thereafter, the first set of pixels may be subjected to a hashing function to obtain the second hash. The area or areas (which can be contiguous or non-contiguous) of the electronic document selected for the second hash can represent the same areas used to generate the first hash, or can represent other areas or partially overlapping areas from that area or those areas used to generate the first hash. Alternately, one or both hashes can be generated based on the entire visible content in the document (e.g., the entire human-readable text and other human-readable content for the first hash and the entire document represented as a set of pixels). Both hashes, in one example, can be calculated based on information on the visible parts of the electronic document (such as human-readable text extracted by an OCR algorithm in a word processing document for the first hash and a graphical representation (e.g., pixels) of that text or other text or the entire human-visible content in the same document for the second hash).

In an example embodiment, once the DVS 102 creates the first hash and the second hash, the DVS 102 may be configured to store the first hash and the second hash in a data store 108 for verifying the authenticity of the content of the electronic document during a second session. Subsequent to the storing, the DVS 102 may be configured to provide the electronic document to the UE 104-1 of the user.

Now, in an example embodiment, the user may seek to verify the authenticity of the content of the electronic document at a later time. For example, consider a case where a user A has got a contract document with a user B. Now after engaging in the first session with the DVS 102, the user A may may have shared the electronic document with user B for his perusal. On receiving back the contract document, the user A may now seek to verify the authenticity of the content of the contract document during a second session with the DVS 102.

In another example, the second session may be requested by another party, other than user A. For instance, consider a case where the user A received some document from the bank, or was issued a character certificate with an expiry date. Now, when the user A submits any of said documents with the corresponding authority, the corresponding authority may request the DVS 102 for verification of the document or character certificate. As would be understood, in said example, the corresponding authority may also be registered with the DVS 102.

In an example embodiment, the DVS 102 may be configured to receive the electronic document during a second session. In said session, the DVS 102 may be configured to create a third hash associated with the electronic document. Herein, the third hash is based on second content included in the electronic document. The second content, as used herein, may be understood as the content of the electronic document as received during the second session. The content herein may be either the complete content or partial content, for example, selected portions of the content corresponding to the selected portion of the first content.

Once the third hash is created, the DVS 102 may be configured to compare the third hash with the first hash. If the third hash is determined to be congruent to the first hash, the DVS 102 may be configured to determine the occurrence of content tampering in the second content.

Furthermore, in an example embodiment, the DVS 102 may be configured to create a fourth hash associated with the electronic document in the second session. In an example, the fourth hash is based on a second set of pixels associated with the electronic document. Again, like the first set of pixels, the second set of pixels may be either a pixel graph or may be obtained by implementing the raster scanning technique. In an example, the DVS 102 may be configured to adopt the same technique for obtaining the second set of pixels, as was adopted in the first set of pixels.

In an example embodiment, once the fourth hash is created, the DVS 102 may be configured to compare the fourth hash with the second hash. In an example, if the fourth hash is determined to be not equal to the second hash, the DVS 102 may be configured to identify one or more pixels in the second set of pixels that are distinct from the first set of pixels. Accordingly, based on the one or more pixels, the DVS 102 may be configured to identify a region of the electronic document where the content tampering has occurred.

In an example, the DVS 102 may perform the whole exercise of creation and comparison of the fourth hash with the second hash, based on a subscription plan of the registered user. That is, only if the user has subscribed to a plan which includes providing details of the region where the content tampering has occurred, the DVS 102 provides such details.

In an example embodiment, the DVS 102 may be configured to generate and provide to the UE 104-1, a verification report based on the processing of the electronic document during the second session. In an example, the verification report may include, at least details, such as whether the content has been tampered with or not. In an example, where the subscription plan of the user is as such, the verification report may also include details of the region, for example, a page number, a section number, a highlighted region, where the content tampering may have occurred.

Thus, aspects of the present subject matter provide for verification of the authenticity of the content of electronic documents, as described above.

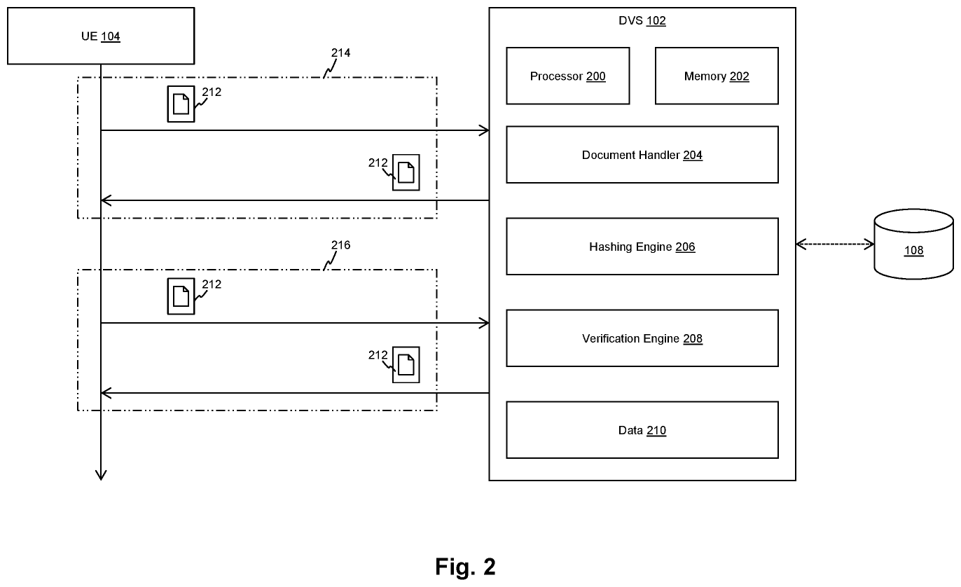

FIG. 2 illustrates, a schematic block diagram illustrating various components of the DVS 102, according to one or more embodiments of the present subject matter. In an example, the system 102 includes a processor 200, memory 202, a document handler 204, a hashing engine 206, a verification engine 208, and data 210. In an example, the memory 202, the document handler 204, the hashing engine 206, and the verification engine 208 are coupled to the processor 200. In an example, the processor 200 may be a single processing unit or a number of units, all of which could include multiple computing units. The processor 200 may be implemented as one or more microprocessors, microcomputers, microcontrollers, digital signal processors, central processing units, state machines, logic circuitries, and/or any devices that manipulate signals based on operational instructions. Among other capabilities, the processor 200 is configured to fetch and execute computer-readable instructions and data stored in the memory 202.

The memory 202 may include any non-transitory computer-readable medium known in the art including, for example, volatile memory, such as static random access memory

(SRAM) and dynamic random access memory (DRAM), and/or non-volatile memory, such as read-only memory (ROM), erasable programmable ROM, flash memories, hard disks, optical disks, and magnetic tapes.

In an example, the document handler 204, the hashing engine 206, and the verification engine 208, amongst other things, include routines, programs, objects, components, data structures, etc., which perform particular tasks or implement data types. The document handler 204, the hashing engine 206, and the verification engine 208 may also be implemented as, signal processor(s), state machine(s), logic circuitries, and/or any other device or component that manipulate signals based on operational instructions. Furthermore, the document handler 204, the hashing engine 206, and the verification engine 208 may be implemented in hardware, instructions executed by a processing unit, or by a combination thereof. The processing unit can comprise a computer, a processor, such as the processor 200, a state machine, a logic array or any other suitable devices capable of processing instructions. The processing unit can be a general-purpose processor that executes instructions to cause the general-purpose processor to perform the required tasks or, the processing unit can be dedicated to perform the required functions.

In another aspect of the present subject matter, the document handler 204, the hashing engine 206, and the verification engine 208 may be machine-readable instructions (software) which, when executed by a processor/processing unit, perform any of the described functionalities. The data 210 serves, amongst other things, as a repository for storing data processed, received, and generated by one or more of the processor 200, document handler 204, the hashing engine 206, and the verification engine 208.

In an example, during a first session 214, the UE 104 may provide an electronic document 212 to the DVS 102. In an example, the document handler 204 may be configured to receive the electronic document 212 from the UE 104.

Upon receiving the electronic document 212, in an example embodiment, the hashing engine 206 may be configured to create a first hash associated with the electronic document 212 based on a predetermined hashing technique. In an example, the first hash may be based created based on first content included in the electronic document 212 and the predetermined hashing technique. For creating the first hash, in an example, the hashing engine 206 may be configured to apply at least one character recognition technique to the electronic document 212 to identify the first content. Examples of the at least one character recognition technique comprises one of a parser and an Optical character Reader (OCR). Once the first content is identified, the predetermined hashing technique is applied by the hashing engine 206 and the first hash is created.

In a further example embodiment, prior to the creation of the first hash, the hashing engine 206 may be configured to create a first summary based on the first content. The first summary may be understood as a partially selected portion of the first content. For example, for a given text document, a couple of paragraphs may be selected. Subsequently, the hashing engine 206 may be configured to create the first hash based on the first summary. In this manner, the hashing engine 206 may provide for a lightweight solution that reduces the computational efforts associated with the creation of first hashes in case of larger text files.

Furthermore, in said example embodiment, the hashing engine 206 may be configured to create a second hash associated with the electronic document 212 based on a predetermined hashing technique. Herein, the second hash is based on a first set of pixels associated with the electronic document. As explained earlier, the first set of pixels may be obtained by implementing a raster scanning technique. In another example, a predetermined technique may be applied on the electronic document 212 to obtain a pixel graph. Based on the pixel graph, the hashing engine 206 then create the second hash. Furthermore, the first set of pixels may be obtained by any other suitable technique.

In an example embodiment, where the electronic document 212 is not in a predefined image format, the hashing engine 206 may be configured to convert the electronic document to the predefined image format. Examples of the predefined image format may include, gif, jpeg, png, metafile, etc. Subsequent to the conversion, the hashing engine 206 may then create the second hash.

In an example, the hashing engine 206 may be configured to use the same technique that is used during the first session for verification of the authenticity of the content of the electronic document 212 in the later sessions, for example, in a second session 216.

In an example embodiment, the verification engine 208 may be configured to store the first hash and the second hash in a data store, such as the data store 108, for verifying the authenticity of the content of the electronic document 212 during the second session 216. In an example embodiment, the verification engine 208 may be configured to assign a document identity (ID) to the electronic document and may store the document ID in the data store. As may be understood, the document ID is unique to the electronic document 212. Furthermore, in said embodiment, the verification engine 208 may be configured to map the document ID with the first hash and the second hash and embed the document ID in metadata of the electronic document. Thus, for the electronic document 212, the data store may include the document ID in a mapped relationship with the first hash and the second hash. Using the document ID, the first hash and the second hash may be easily obtained from the data store during later sessions.

In an example embodiment, the verification engine 208 may be configured to provide the electronic document 212 to the UE 104. The UE 104 may subsequently provide the electronic document 212 to other UEs 104.

In an example embodiment, during the second session 216, the UE 104 may provide the electronic document 212 to the DVS 102 for verifying the authenticity of the content of the electronic document. As explained above in the description of FIG. 1, the UE 104 may be the same UE or may be a different UE.

In an example embodiment, the document handler 204 may be configured to receive the electronic document 212 in the second session. Once the electronic document is received, the hashing engine 206 may be configured to create a third hash associated with the electronic document based on a predetermined hashing technique. The third hash may be based on second content included in the electronic document 212. As may be understood, the predetermined hashing technique is same as the one used in the first session. For creating the third hash, in an example, the hashing engine 206 may be configured to apply at least one character recognition technique to the electronic document 212 to identify the third content. Examples of the at least one character recognition technique comprises one of a parser and an Optical character Reader

(OCR). Once the third content is identified, the predetermined hashing technique is applied by the hashing engine 206 and the third hash is created.

In a further example embodiment, prior to the creation of the third hash, the hashing engine 206 may be configured to create a second summary based on the second content. The second summary may be understood as a partially selected portion of the second content that corresponds to the first summary of the first content. For example, text from the same page or section may be taken. Subsequently, the hashing engine 206 may be configured to create the third hash based on the first summary.

After creating the third hash, the verification engine 208 may be configured to compare the third hash with the first hash. To that end, the verification engine 208 may be configured to ascertain the document ID of the electronic document 212 and obtain the first hash from the data store based on the document ID.

In an example, if the third hash is determined to be congruent to the first hash, then in such a case, the verification engine 208 may be configured to determine the occurrence of content tampering in the second content.

In an example embodiment, the hashing engine 206 may be further configured to create a fourth hash associated with the electronic document in the second session. The fourth hash may be based on a second set of pixels associated with the electronic document. In an example, the hashing engine 206 creates the fourth hash in a similar manner as the creation of the second hash of the first session, as explained above. Once the fourth hash is created, the verification engine 208 may be configured to compare the fourth hash with the second hash. To that end, the verification engine 208 may be configured to ascertain the document ID of the electronic document 212 and obtain the second hash from the data store based on the document ID

In an example, if the fourth hash is determined to be not equal to the second hash, the verification engine 208 may be configured to identify one or more pixels in the second set of pixels that are distinct from the first set of pixels. Accordingly, based on the one or more pixels, the verification engine 208 may be configured to identify a region of the electronic document where the content tampering has occurred.

In an example embodiment, as also explained in the description of FIG. 1, the verification engine 208 may be configured to generate and provide to the UE 104, a verification report based on the processing of the electronic document 212 during the second session. In an example, the verification report may include, at least details, such as whether the content has been tampered with or not. In an example, where the subscription plan of the user is as such, the verification report may also include details of the region, for example, a page number, a section number, a highlighted region, where the content tampering may have occurred.

In a further example embodiment, the document ID of the electronic document comprises at least one of a unique ID associated with the document, a common linking ID, a language code, and a sequence code. Herein, the unique ID is unique to the electronic document 212. The common linking ID may be understood as an ID that may be assigned to a plurality of electronic documents that the user wants to link together. For example, the user may want to link or associate documents having the same content but in different languages. Accordingly, the language code may indicate a language of the content. Furthermore, the sequence code may indicate the order/rank of the document in the plurality of linked documents.

Continuing with the above embodiment, the verification engine 208 may be further configured to receive a further electronic document that is to be linked with the electronic document 212. Subsequently, the verification engine 208 may be configured to assign a further document ID to the further electronic document. Herein, the further document ID comprises at least the common linking ID. Accordingly, the verification engine 208 may be configured to store the further document ID in the data store in a mapped relationship with the document ID of the electronic document 212 based on the common linking ID.

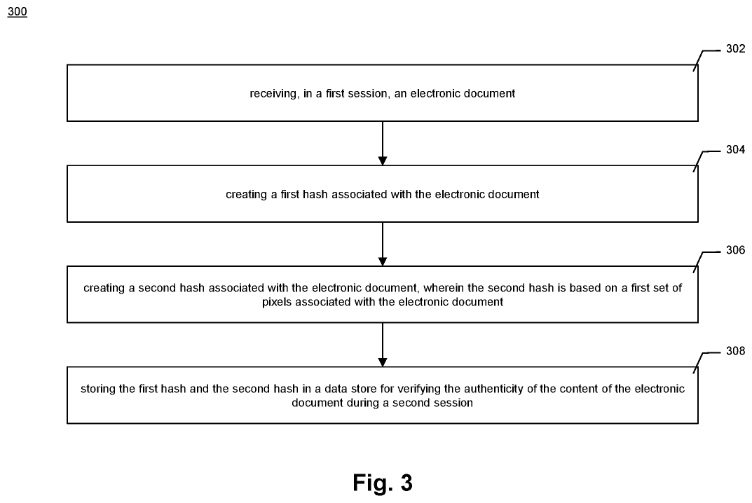

FIG. 3 illustrates a computer-implemented method 300 of verifying the authenticity of the content of electronic documents, according to one or more embodiments of the present subject matter. The method 300 may be implemented using one or more components of the DVS 102. For the sake of brevity, details of the present disclosure that have been explained in detail with reference to the descriptions of FIGS. 1 and 2 above are not explained in detail herein.

The method 300 commences at step 302, where, in a first session, an electronic document is received.

At step 304, a first hash associated with the electronic document is created. In an example, the first hash is based on first content of the electronic document. In an example embodiment, the method 300 includes applying at least one character recognition technique to the electronic document to identify the first content. Herein, the at least one character recognition technique comprises one of a parser and an Optical character Reader (OCR).

Subsequently, a predetermined hashing technique may be applied on the first content to obtain the first hash.

Furthermore, in an example embodiment, the creation of the first hash includes, at first, creating a first summary based on the first content. Subsequently, the first hash may be created based on the first summary.

At step 306, a second hash associated with the electronic document is created. In an example, the second hash is based on a first set of pixels associated with the electronic document. In an example, the creation of the second hash includes converting the electronic document to a predefined image format and then creating the second hash based on the converted document.

At step 308, the first hash and the second hash are stored in a data store for verifying the authenticity of the content of the electronic document during a second session.

In an example, the method 300 further comprises assigning a document identity (ID) to the electronic document. Herein the document ID is stored in the data store. The method 300 further comprises mapping the document ID with the first hash and the second hash.

Furthermore, the method further comprises embedding the document ID in metadata of the electronic document.

In an example embodiment, the document ID of the electronic document comprises at least one of a unique ID associated with the electronic document, a common linking ID, a language code, and a sequence code. In said example embodiment, the method 300 further comprises receiving a further electronic document that is to be linked with the electronic document. The method 300 further comprises assigning a further document ID to the further electronic document, wherein the further document ID comprises at least the common linking ID; Furthermore, the method 300 comprises storing the further document ID in the data store in a mapped relationship with the document ID of the electronic document based on the common linking ID.

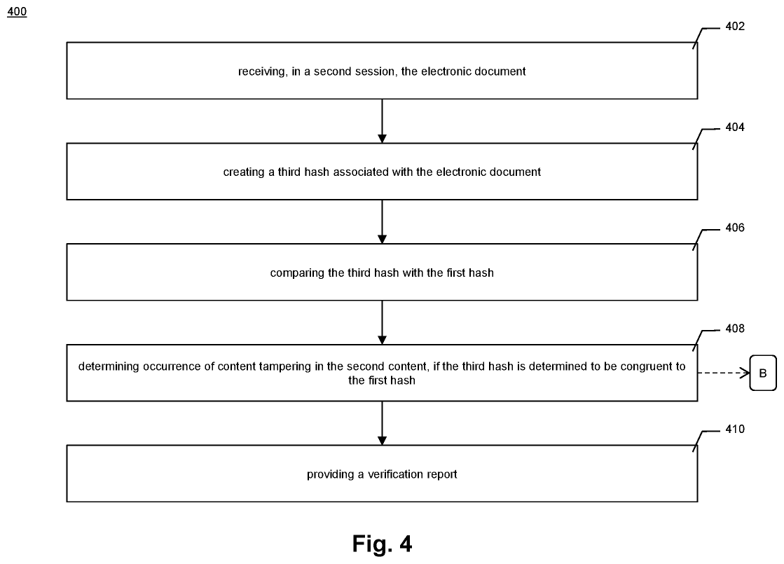

FIG. 4 illustrates a computer-implemented method 400 of verifying the authenticity of the content of electronic documents, according to one or more embodiments of the present subject matter. The method 400 may be implemented using one or more components of the DVS 102. For the sake of brevity, details of the present disclosure that have been explained in detail with reference to descriptions of FIGS. 1, 2, and 3 above are not explained in detail herein.

The method 400 commences at step 402, where, in a second session, the electronic document is received.

At step 404, a third hash associated with the electronic document is created. In an example, the third hash is based on second content included in the electronic document. In an example embodiment, the method 400 includes applying at least one character recognition technique to the electronic document to identify the second content. Herein, the at least one character recognition technique comprises one of a parser and an Optical character Reader (OCR). Subsequently, a predetermined hashing technique may be applied on the second content to obtain the third hash.

Furthermore, in an example embodiment, the creation of the third hash includes, at first, creating a second summary based on the second content. Subsequently, the third hash may be created based on the second summary.

In an example embodiment, the method 400 further comprises ascertaining, in the second session, the document ID of the electronic document. The method 400 further comprises obtaining the first hash from the data store based on the document ID.

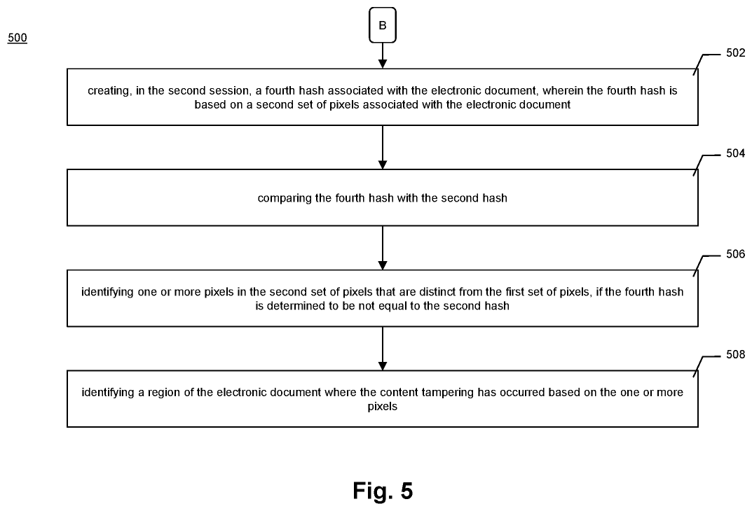

At step 406, the third hash is compared with the first hash. In an example, if the third hash is determined to be congruent to the first hash, then at step 408, the occurrence of content tampering in the second content is determined. In an example embodiment, on said determining, the method may further include performing steps of method 500, as described in FIG. 5 below, and referred to herein as letter “B”.

Subsequently, at step 410, a verification report is provided.

FIG. 5 illustrates a computer-implemented method 500 of verifying the authenticity of the content of electronic documents, according to one or more embodiments of the present subject matter. The method 500 may be implemented using one or more components of the DVS 102. For the sake of brevity, details of the present disclosure that have been explained in detail with reference to descriptions of FIGS. 1, 2, 3, and 4 above are not explained in detail herein.

The method 500 commences at step 502, where, a fourth hash associated with the electronic document is created. The fourth hash is based on a second set of pixels associated with the electronic document. In an example, the creation of the fourth hash includes converting the electronic document to a predefined image format and then creating the fourth hash based on the converted document.

In an example embodiment, the method 500 further comprises ascertaining, in the second session, the document ID of the electronic document. The method 500 further comprises obtaining the second hash from the data store based on the document ID.

At step 504, the fourth hash is compared with the second hash. In an example, if the fourth hash is determined to be not equal to the second hash, then at step 506, one or more pixels in the second set of pixels that are distinct from the first set of pixels are identified.

Subsequently, at step 508, a region of the electronic document where the content tampering has occurred is identified based on the one or more pixels. Thereafter, in an example, the method may continue to step 410 as explained above.

According to some embodiments of the present disclosure, processes described above with reference to flow charts or flow diagrams (e.g., in FIGS. 2-5) may be implemented in a computer software program. For example, some embodiments of the present disclosure include a computer program product, which includes a computer program that is carried in a computer readable medium. The computer program includes program codes for executing the method 300, the method 400, and/or the method 500. The computer program may be downloaded and installed from a network (e.g., the Internet, a local network, etc.) and/or may be installed from a removable medium (e.g., a removable hard drive, a flash drive, an external drive, etc.). The computer program, when executed by a central processing unit (e.g., the processor 200), implements the above functions defined by methods and flow diagrams provided herein in the present disclosure.

A computer readable medium according to the present disclosure may be a computer readable signal medium or a computer readable storage medium or any combination of the above two. Examples of the computer readable storage medium may include electric, magnetic, optical, electromagnetic, infrared, or semiconductor systems, elements, apparatuses, or a combination of any of the above. More specific examples of the computer readable storage medium include a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above.

The computer readable storage medium according to some embodiments may be any tangible medium containing or storing programs, which may be used by, or used in combination with, a command execution system, apparatus or element. In some embodiments of the present disclosure, the computer readable signal medium may include a data signal in the base band or propagating as a part of a carrier wave, in which computer readable program codes are carried. The propagating data signal may take various forms, including but not limited to an electromagnetic signal, an optical signal, or any suitable combination of the above. The computer readable signal medium may also be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium, including but not limited to: wireless, wired, optical cable, RF medium, etc., or any suitable combination of the above.

A computer program code for executing operations in the present disclosure may be compiled using one or more programming languages or combinations thereof. The programming languages include object-oriented programming languages, such as Java or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or electronic device. In the circumstance involving a remote computer, the remote computer may be connected to a user's computer through any network, including local area network (LAN) or wide area network (WAN), or be connected to an external computer (for example, connected through the Internet using an Internet service provider).

The flow charts and block diagrams in the accompanying drawings illustrate architectures, functions and operations that may be implemented according to the systems, methods and computer program products of the various embodiments of the present disclosure.

Each of the blocks in the flow charts or block diagrams may represent a program segment or code that includes one or more executable instructions for implementing specified logical functions. It should be further noted that, in some alternative implementations, the functions denoted by the flow charts and block diagrams may also occur in a sequence different from the sequences shown in the figures. For example, any two blocks presented in succession may be executed substantially in parallel, or sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

Engines, handlers, or any other software block or hybrid hardware-software block identified in some embodiments of the present disclosure may be implemented by software, or may be implemented by hardware. The described blocks may also be provided in a processor, for example, described as: a processor including a document handler, a hashing engine, a verification engine, etc.

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

I/we claim:

1. A computer-implemented method of verifying authenticity of content of electronic documents, the method comprising:
receiving, in a first session, an electronic document;
creating a first hash associated with the electronic document, wherein the first hash is based on first content included in the electronic document;
creating a second hash associated with the electronic document, wherein the second hash is based on a first set of pixels associated with the electronic document;
storing the first hash and the second hash in a data store for verifying the authenticity of the content of the electronic document during a second session.

2. The method of claim 1, further comprising:
receiving, in the second session, the electronic document;
creating a third hash associated with the electronic document, wherein the third hash is based on second content included in the electronic document;
comparing the third hash with the first hash; and
determining occurrence of content tampering in the second content, if the third hash is determined to be congruent to the first hash.

3. The method of claim 2, further comprising:
creating, in the second session, a fourth hash associated with the electronic document, wherein the fourth hash is based on a second set of pixels associated with the electronic document;
comparing the fourth hash with the second hash;
identifying one or more pixels in the second set of pixels that are distinct from the first set of pixels, if the fourth hash is determined to be not equal to the second hash; and
identifying a region of the electronic document where the content tampering has occurred based on the one or more pixels.

4. The method of claim 3, further comprising:
assigning a document identity (ID) to the electronic document, wherein the document ID is stored in the data store;
mapping the document ID with the first hash and the second hash; and
embedding the document ID in metadata of the electronic document.

5. The method of claim 4, further comprising:
ascertaining, in the second session, the document ID of the electronic document; and
obtaining the first hash and the second hash from the data store based on the document ID.

6. The method of claim 4, wherein the document ID of the electronic document comprises at least one of a unique ID associated with the electronic document, a common linking ID, a language code, and a sequence code.

7. The method of claim 6, further comprising:
receiving a further electronic document that is to be linked with the electronic document;
assigning a further document ID to the further electronic document, wherein the further document ID comprises at least the common linking ID; and
storing the further document ID in the data store in a mapped relationship with the document ID of the electronic document based on the common linking ID.

8. The method of claim 2, further comprising applying at least one character recognition technique to the electronic document to identify the first content and the second content, wherein the at least one character recognition technique comprises one of a parser and an Optical character Reader (OCR).

9. The method of claim 2, further comprising:
creating a first summary based on the first content;
creating the first hash based on the first summary;
creating a second summary based on the second content; and
creating the third hash based on the second summary.

10. The method of claim 3, further comprising converting the electronic document to a predefined image format.

11. A document verification system for verifying authenticity of content of electronic documents, the system comprising:
a processor;
a document handler coupled to the processor and configured to receive, in a first session, an electronic document;
a hashing engine coupled to the processor and configured to:
create a first hash associated with the electronic document, wherein the first hash is based on first content included in the electronic document;
create a second hash associated with the electronic document, wherein the second hash is based on a first set of pixels associated with the electronic document;
a verification engine coupled to the processor and configured to store the first hash and the second hash in a data store for verifying the authenticity of the content of the electronic document during a second session.

12. The system of claim 11, wherein:
the document handler is further configured to receive the electronic document in the second session;
the hashing engine is further configured to create a third hash associated with the electronic document, wherein the third hash is based on second content included in the electronic document; and
the verification engine is further configured to:
compare the third hash with the first hash; and
determine occurrence of content tampering in the second content, if the third hash is determined to be congruent to the first hash.

13. The system of claim 12, wherein:
the hashing engine is further configured to create, in the second session, a fourth hash associated with the electronic document, wherein the fourth hash is based on a second set of pixels associated with the electronic document; and
the verification engine is further configured to:
compare the fourth hash with the second hash; and
identify one or more pixels in the second set of pixels that are distinct from the first set of pixels, if the fourth hash is determined to be not equal to the second hash; and
identify a region of the electronic document where the content tampering has occurred based on the one or more pixels.

14. The system of claim 13, wherein the verification engine is further configured to:
assign a document identity (ID) to the electronic document, wherein the document ID is stored in the data store;
map the document ID with the first hash and the second hash; and
embed the document ID in metadata of the electronic document.

15. The system of claim 14, wherein the verification engine is further configured to:
ascertain, in the second session, the document ID of the electronic document; and
obtain the first hash and the second hash from the data store based on the document ID.

16. The system of claim 14, wherein the document ID of the electronic document comprises at least one of a unique ID associated with the electronic document, a common linking ID, a language code, and a sequence code.

17. The system of claim 16, wherein the verification engine is configured to:
receive a further electronic document that is to be linked with the electronic document;
assign a further document ID to the further electronic document, wherein the further document ID comprises at least the common linking ID; and
store the further document ID in the data store in a mapped relationship with the document ID of the electronic document based on the common linking ID.

18. The system of claim 12, wherein the hashing engine is further configured to apply at least one character recognition technique to the electronic document to identify the first content and the second content, wherein the at least one character recognition technique comprises one of a parser and an Optical character Reader (OCR).

19. The system of claim 12, wherein the hashing engine is further configured to:
create a first summary based on the first content;
create the first hash based on the first summary;
create a second summary based on the second content; and
create the third hash based on the second summary.

20. The system of claim 13, wherein the hashing engine is further configured to convert the electronic document to a predefined image format.
